(19) United States
(12) Patent Application Publication
(10) Pub. No.: US 2024/0402686 A1
(43) Pub. Date: Dec. 5, 2024

(54) REMOTE SUPPORT SYSTEM

(71) Applicant: FANUC CORPORATION, Yamanashi (JP)

(72) Inventors: Masahiro MORIOKA, Yamanashi (JP); Norimichi YOSHIDA, Yamanashi (JP); Shuuhei OGAWA, Yamanashi (JP); Seigo KATO, Yamanashi (JP); Kenichiro ABE, Yamanashi (JP)

(21) Appl. No.: 18/699,007

(22) PCT Filed: Dec. 2, 2021
(86) PCT No.: PCT/JP2021/044255

§ 371 Date: Apr. 5, 2024

(51) Int. Cl. G05B 19/418

(52) U.S. Cl. CPC G05B 19/4185; G05B 2219/35414

(57) ABSTRACT

A remote support system includes a control device configured to control an industrial machine, a first information processing terminal connected to the control device directly or via a network line, and a second information processing terminal connected to the control device or the first information processing terminal directly or via the network line. The remote support system is configured so that the first information processing terminal is able to permit/not permit remote operation of the control device or the first information processing terminal from the second information processing terminal.

### TECHNICAL FIELD

This disclosure relates generally to a remote support system.

### BACKGROUND ART

In recent years, industrial machinery such as robots and machine tools introduced into manufacturing factories has become increasingly sophisticated. Therefore, there are cases in which workers on site alone cannot resolve unforeseen situations, such as when an industrial machine stops and does not move. In such cases, a person in charge of the work makes an inquiry to a manufacturer's person in charge by e-mail, telephone, or the like, and the person in charge of the work and workers on site operate the industrial machine as instructed by the manufacturer's person in charge. If the problem still cannot be solved, the schedule will be adjusted and a manufacturer's technician will directly visit the site to deal with the problem. It is good if the manufacturer's person in charge can visit the site immediately, but if the manufacturer's person in charge cannot visit the site immediately, the task will be suspended for a long period of time, causing a delay in the manufacturing schedule. To solve this problem, Patent Literature 1 discloses a remote operation system for realizing support by a service person when a trouble occurs in a robot. Such support by remote operation is an effective means for preventing a delay or the like in the manufacturing schedule.

However, in the remote operation system, an operation unintended by workers on site which is performed by a third party who has infiltrated the system or a service person who is a remote operator may cause a problem. For example, the robot may be moved by an operator who does not understand the on-site situation, and the robot may collide with workers or obstacles on site. In addition, data of the information processing terminal being remotely operated may be illegally accessed. As described above, there is room for improvement in terms of safety against service personnel performing remote operations and intruders into the network, as well as in terms of on-site safety during remote operations, and a remote support system with a higher level of safety is desired.

### CITATION LIST

### Patent Literature

Patent Literature 1: Japanese Unexamined Patent Application Publication No. 2001-142512

### BRIEF DESCRIPTION OF THE DRAWINGS

FIG. 1 is a diagram showing an example of a remote support system according to the present embodiment.

FIG. 2 is a block configuration diagram of the remote support system shown in FIG. 1.

FIG. 3 is a sequence showing an example of a procedure until remote operation of a control device is performed by a remote terminal shown in FIG. 1.

FIG. 4 is a diagram showing an example of a reception page displayed on an operation terminal shown in FIG. 1.

FIG. 5 is a diagram showing an example of a remote operation page displayed on the remote terminal shown in FIG. 1.

FIG. 6 is a sequence showing another example of the procedure until remote operation of the control device is performed by the remote terminal shown in FIG. 1.

FIG. 7 is a sequence showing a procedure of pre-registration processing of the remote terminal to the control device shown in FIG. 1.

FIG. 8 is a diagram showing another example of the remote support system according to the present embodiment.

### DETAILED DESCRIPTION OF THE INVENTION

A remote support system according to one aspect of the present disclosure includes a control device configured to control an industrial machine, a first information processing terminal connected to the control device directly or via a network line, and a second information processing terminal connected to the control device or the first information processing terminal directly or via the network line. The remote support system is configured so that the first information processing terminal is able to permit/not permit remote operation to the control device or the first information processing terminal from the second information processing terminal.

Hereinafter, a remote support system according to an embodiment of the present invention will be described with reference to the drawings. In the following description, constituent elements having substantially the same function and configuration are denoted by the same reference numeral, and repetitive descriptions will be given only where necessary.

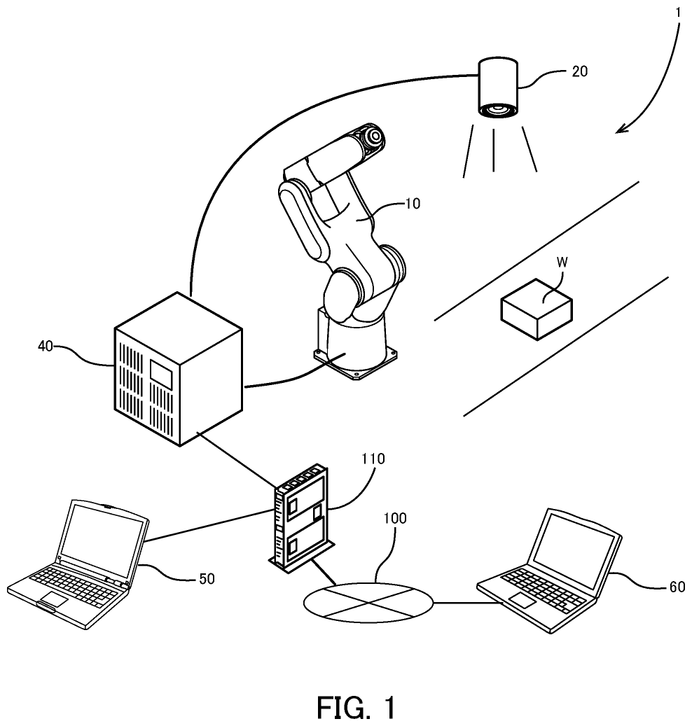

As shown in FIG. 1, a remote support system 1 according to the present embodiment includes a robot arm mechanism 10 installed in a factory, which corresponds to an industrial machine, a camera 20 for capturing an image of a workpiece, which corresponds to a peripheral device of the industrial machine, a control device 40 that controls the robot arm mechanism 10 and the camera 20, a first information processing terminal 50 (operation terminal 50) used by a user to operate the control device 40, and a second information processing terminal 60 (remote terminal 60) used by a maintenance contractor, a technician of a manufacturer, or the like to remotely operate the control device 40. The operation terminal 50 can be a general-purpose terminal such as a PC or a tablet, a dedicated operation pendant, and a programmable logic controller (PLC) that performs overall control of the control device 40. The remote terminal 60 can be a general-purpose terminal such as a PC or a tablet.

Typically, the robot arm mechanism 10 and the camera 20 are each directly connected to the control device 40 by a wired cable. The control device 40 and the operation terminal 50 are connected to a router 110 in accordance with a wireless LAN standard. The control device 40 and the operation terminal 50 can freely communicate with each other via the router 110. In addition, the control device 40 and the operation terminal 50 can be connected to the Internet 100 via the router 110. The remote terminal 60 can be connected to the control device 40 and the operation terminal 50 via the Internet 100. Of course, a hub may be connected to the router 110 by a wired cable, and the control device 40 and the operation terminal 50 may be each connected to the hub by a wired cable.

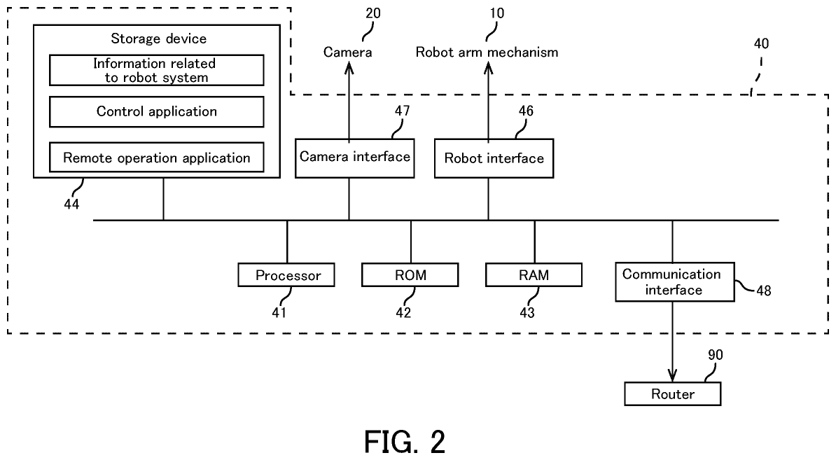

As shown in FIG. 2, the control device 40 is connected to the robot arm mechanism 10, the camera 20, and the router 110 via interfaces 46, 47, and 48, respectively. The control device 40 can be connected to the operation terminal 50 and the Internet via the router 110.

The control device 40 includes a processor 41. The processor 41 is constituted by a central processing unit (CPU), a graphics processing unit (GPU), and the like, and performs overall control of the devices and controllers connected to a system bus. A ROM 42 stores a basic input output system (BIOS), an operating system program (OS), and the like executed by the processor 41. A RAM 43 functions as a main memory, a work area, or the like of the processor 41.

A storage device 44 stores information related to the robot system, a control application, a remote operation application, and the like.

The information related to the robot system includes a task program for causing the robot system to execute a predetermined task, setting information of the robot arm mechanism 10, setting information of the camera 20, and the like. The setting information of the robot arm mechanism 10 includes, for example, parameter information, related to operation of the robot arm mechanism 10 such as an operation speed, an acceleration, and an operating range, and on/off information of functions of the robot arm mechanism 10, and parameter information and on/off information of functions related to operation of a hand (end effector) mounted on the robot arm mechanism 10. The setting information of the camera 20 includes an image capturing range, an image capturing speed, and the like.

The control application is software for controlling the robot arm mechanism 10 and the camera 20. The control application is executed by the processor 41 to realize a process of providing a control page to the operation terminal 50 registered in advance in the control device 40 and a process of controlling the robot arm mechanism 10 and the camera 20 based on a user operation on the control page. The control here includes direct control of the motors of joints of the robot arm mechanism 10, modification of a task program, and modification, change, and addition of information related to the robot system, such as change of setting information.

The remote operation application is software that performs processing related to remote operation. The remote operation application is executed by the processor 41 to realize a process of providing an application page to the remote terminal 60, a process of receiving a remote operation application from the remote terminal 60, a process of providing a reception page to the operation terminal 50 of the user who determines whether or not to accept remote operation (process of transferring the remote operation application), a process of providing a remote operation page to the remote terminal 60 permitted to perform remote operation, and a process of changing data based on an operation on the remote operation page.

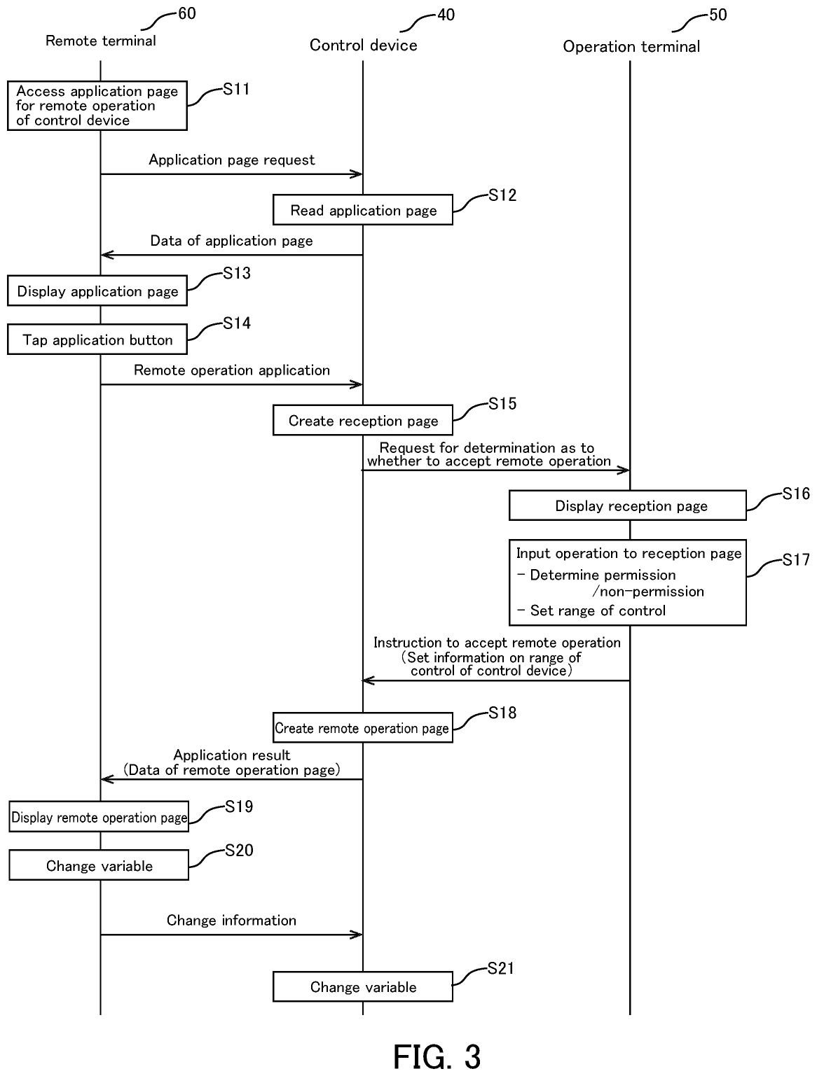

With reference to FIG. 3, an example of the procedure from an application of remote operation of the control device 40 from the remote terminal 60 to the remote operation of the control device 40 by the remote terminal 60 will be described below.

By an operation of an applicant applying for remote operation of the control device 40, a browser is activated in the remote terminal 60, and a URL of an application page for remote operation of the control device 40 is input on the browser screen (step S11). The browser of the remote terminal 60 identifies the control device 40 by the IP address corresponding to the input URL, and requests an application page for remote operation.

The control device 40 reads data of an HTML file of the application page for remote operation requested from the browser of the remote terminal 60, and transmits the data to the browser of the remote terminal 60 (step S12).

The browser of the remote terminal 60 analyzes the HTML file and displays the application page for remote operation (step S13). The application page includes entry fields for applicant information to identify the applicant, such as the name and affiliation of the applicant (e.g., maintenance worker). When the input of the required items is completed on the application page and an application button is tapped, the browser of the remote terminal 60 transmits the remote operation application to the control device 40 (step S14). The remote operation application is accompanied by terminal information to identify the remote terminal 60 that is the source of the remote operation, device information to identify the control device 40 that is the target of the remote operation, and applicant information input on the application page.

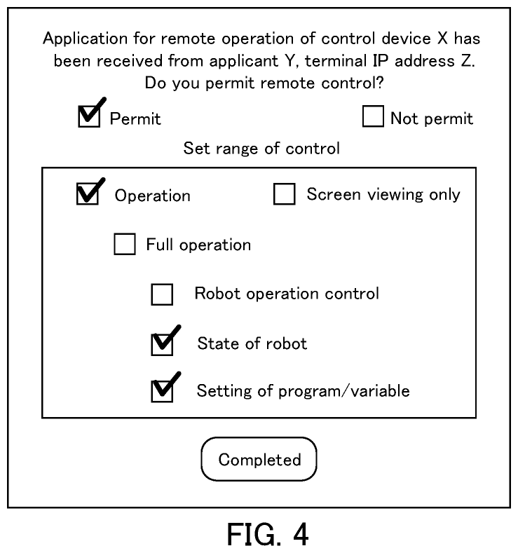

Based on the various types of information received together with the remote operation application, the control device 40 creates a reception page for receiving a determination on whether to accept the remote operation as shown in FIG. 4 from a user. Then, a determination request as to whether to accept the remote operation is transmitted to the operation terminal 50 of the user (person in charge of management) registered in advance in the control device 40 by a transmission means such as an e-mail or a push notification (step S15). A link to the reception page is included in this determination request.

When the link included in the received determination request is tapped by a user operation of the operation terminal 50, the browser is activated, and the reception page is displayed by the browser (step S16). By a user operation on the reception page, permission or non-permission of the remote operation of the control device 40 by the remote terminal 60 is selected, and in the case of permission, a range of control of the control device 40 is input. Here, let us assume that the remote operation of the control device 40 by the remote terminal 60 is permitted and the range of control is set to a predetermined range, as shown in FIG. 4. When the input of the required items is completed on the reception page and the completion button is tapped, the browser of the operation terminal 50 transmits an instruction to accept the remote operation to the control device 40 which requested the input (step S17). The acceptance instruction includes setting information on the range of control, and the like.

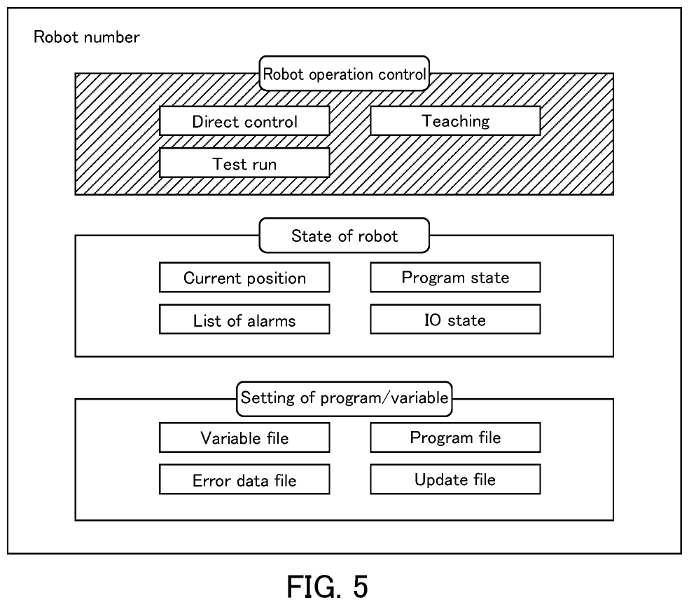

Upon receiving the instruction to accept the remote operation, the control device 40 creates a remote operation page as shown in FIG. 5 based on the setting information on the range of control, and transmits the remote operation page as an application result to the remote terminal 60 which applied for the remote operation (step S18). In this case, since the remote operation is permitted, data of the remote operation page is transmitted to the remote terminal 60 as the application result, but when the remote operation is not permitted, data of a notification page that notifies that fact is transmitted to the remote terminal 60.

Upon receiving the application result, the browser of the remote terminal 60 displays the remote operation page (step S19). The applicant, such as a maintenance contractor or a manufacturer's technician, can remotely operate the control device 40 via the remote operation page. For example, when the value of a specific variable is changed by an operation on the remote operation page (step S20), change information is transmitted to the control device 40. The control device 40 changes the value of the specific variable based on the change information received from the remote terminal 60 (step S21).

FIG. 4 shows an example of the reception page displayed on the operation terminal 50. As shown in FIG. 4, the reception page includes applicant information for identifying the applicant who has applied for the remote operation, terminal information of the remote terminal 60 for identifying the remote terminal 60 which has applied for the remote operation, device information of the control device 40 for identifying the control device 40 for which the remote operation has been applied, selection boxes for selecting permission/non-permission of the application, and selection boxes for setting the range of control. FIG. 4 shows that the remote operation of the control device 40 by the remote terminal 60 is permitted and, as the range of control, the operation of confirming the state of the robot and the operation of changing a program/variable of the robot are permitted, and the operation of directly controlling the operation of the robot is not permitted. When the completion button is tapped, the input information is transmitted to the control device 40 identified by the device information.

FIG. 5 shows an example of the remote operation page displayed on the remote terminal 60. The remote operation page corresponds to the range of control set on the reception page of FIG. 4. As shown in FIG. 5, since the operation of confirming the state of the robot is permitted, buttons corresponding to various items related to the state of the robot are enabled so that they can be selected. Similarly, since the operation of changing the program/variable of the robot is permitted, buttons corresponding to various items related to the change of the program/variable of the robot are enabled so that they can be selected. On the other hand, since the operation of directly controlling the operation of the robot is not permitted, buttons corresponding to various items related to the robot operation control are disabled so that they cannot be selected. As described above, the remote operation page is configured such that the remote operator cannot control the control device 40 beyond the range of control set by the user.

According to the remote support system 1 of the present embodiment described above, the acceptance of the remote operation of the control device 40 by the remote terminal 60 can be determined at the external operation terminal 50 connected to the control device 40, instead of being determined at the control device 40 which is the target of the remote operation (party). When the remote operation is applied for by the remote terminal 60 to the control device 40, the application for the remote operation is transferred to the operation terminal 50 of the user, allowing the user to respond immediately, even if the user is not on site. Being able to permit or not permit the remote operation at the operation terminal 50 in response to the remote operation application from the remote terminal 60 can shorten the time from the remote operation application to the permission, and can also shorten, for example, the time to stop the robot system. As described above, according to the remote support system 1 of the present embodiment, it is possible to save time and effort on the part of the user who manages the industrial machine that is the target of the remote operation.

Further, the user can arbitrarily set the range of control of the control device 40 by the remote terminal 60 via the operation terminal 50. Since the remote operation applicant cannot control the control device 40 beyond the range of control set by the user, it is possible to prevent data tampering, such as a change of setting information or the like held in the control device 40 in a range not permitted by the user. In addition, in many cases, the operator who operates the remote terminal 60 is not on site, and therefore cannot grasp the situation at the site in detail. Therefore, the possibility that the remote operation of the control device 40 could endanger on-site workers cannot be completely ruled out. However, the above situation can also be avoided by setting the range of control so that the items for actually operating the industrial machine and the items that may endanger workers cannot be controlled. As described above, the remote support system 1 according to the present embodiment can ensure on-site safety in remote operation, and also prevent data tampering.

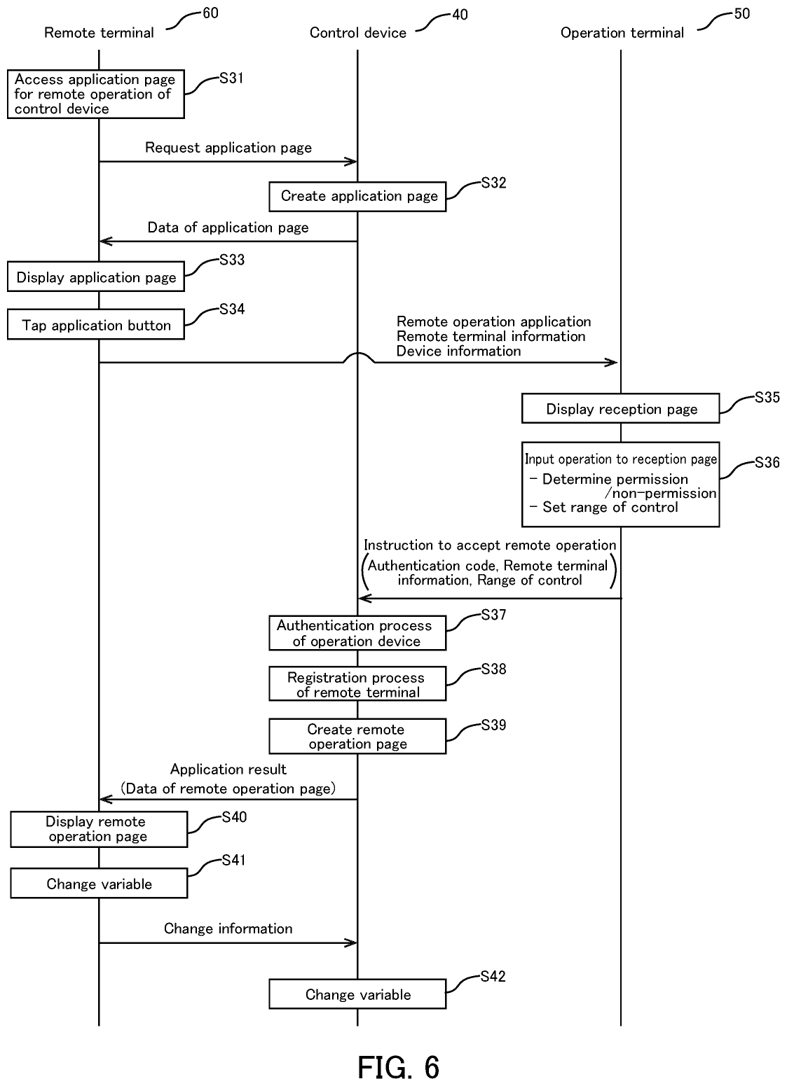

In the procedure described with reference to FIG. 3, when remote operation is applied for from the remote terminal 60 to the control device 40, the application content is transferred to the operation terminal 50 of the user who determines whether to accept the remote operation of the control device 40, but the remote operation application may be directly sent from the remote terminal 60 to the operation terminal 50. With reference to FIG. 6, another example of the procedure from the application of remote operation of the control device 40 from the remote terminal 60 to the remote operation of the control device 40 by the remote terminal 60 will be described below. Steps S31 to S34 in FIG. 6 correspond to steps S11 to S14 in FIG. 3, respectively, steps S35 and S36 in FIG. 6 correspond to steps S16 and S17 in FIG. 3, respectively, and steps S39 to S42 in FIG. 6 correspond to steps S18 to S21 in FIG. 3, respectively; therefore, detailed descriptions of these steps will be omitted.

In the operation terminal 50, an application for receiving an application for remote operation of the control device 40 by the remote terminal 60 is installed. By the processor executing the application, the operation terminal 50 can receive an application for remote operation from the remote terminal 60, display a reception page, and transmit various types of information input by a user operation on the reception page to the control device 40 that is the target of the remote operation.

As shown in FIG. 6, in the process of step S34, when the input of the required items on the application page displayed on the remote terminal 60 is completed and the application button is tapped, the browser of the remote terminal 60 identifies the operation terminal 50 based on user information associated with the application page and transmits the remote operation application. The user information is information that identifies a user who manages the control device 40 that is the target of the remote operation, such as an email address or terminal information of the operation terminal 50. The remote operation application is accompanied by terminal information to identify the remote terminal 60 that is the source of the remote operation, device information to identify the control device 40 that is the target of the remote operation, and applicant information input on the application page.

The operation terminal 50 creates and displays a remote operation reception page as shown in FIG. 4 based on the various types of information received together with the remote operation application (step S35). When the input of the required items is completed on the reception page and the completion button is tapped, the operation terminal 50 identifies the control device 40 that is the target of the remote operation, based on the device information, and transmits an instruction to accept the remote operation (step S36). The instruction to accept the remote operation is accompanied by an authentication code indicating that the operation terminal 50 has the right to permit the remote operation of the control device 40 to the remote terminal 60, terminal information of the remote terminal 60 that has applied for the remote operation, and setting information of the range of control of the control device 40 by the remote operation.

Upon receiving the acceptance instruction from the operation terminal 50, the control device 40 authenticates the operation terminal 50 based on the authentication code (step S37), and registers the terminal information of the remote terminal 60 and the setting information of the range of control in association with each other in a list of terminals to accept remote operation (step S38). Then, the control device 40 creates a remote operation page as shown in FIG. 5, and transmits it as an application result to the remote terminal 60 identified by the terminal information (step S39). As a result, the remote operation page is displayed on the remote terminal 60 (step S40), and when, for example, a variable is changed by an operation by the maintenance worker on the remote operation page (step S41), change information is transmitted to the control device 40. Upon receiving the change information from the remote terminal 60, the control device 40 changes the variable based on the change information (step S42).

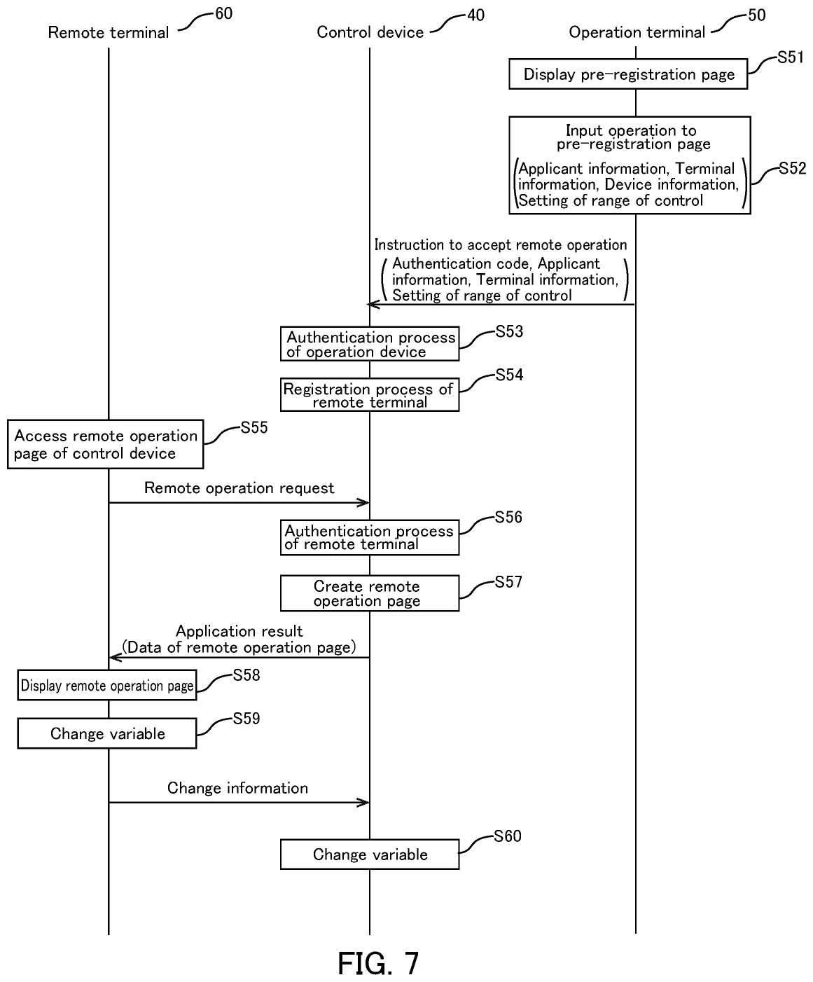

In the procedure described with reference to FIG. 6, the process of registering the remote terminal 60 in the control device 40 is executed in response to the remote operation application of the control device 40 from the remote terminal 60. However, the registration process of the remote terminal 60 may be performed in advance. With reference to FIG. 7, a procedure in the case where the remote terminal 60 from which remote operation of the control device 40 is accepted is registered in advance will be described below. Steps S51 to S54 in FIG. 7 correspond to steps S35 to S38 in FIG. 6, step S55 in FIG. 7 corresponds to step S31 in FIG. 6, and steps S57 to S60 in FIG. 7 correspond to steps S39 to S42 in FIG. 6, respectively; therefore, descriptions of details of these steps will be omitted.

The user obtains information necessary for registration to the acceptance list for remote operation of the control device 40 from the applicant (applicant information, terminal information of the remote terminal 60 that is the source of the remote operation, device information of the control device 40 that is the target of the remote operation) in advance by means of e-mail or the like.

As shown in FIG. 7, a pre-registration page is displayed on the operation terminal 50 by a user operation (step S51), and the applicant information, the terminal information of the remote terminal 60 that is the source of the remote operation, the device information of the control device 40 that is the target of the remote operation, and the range of control of the control device 40, which were obtained in advance on the pre-registration page, are input. When the input is completed and the completion button is tapped, the operation terminal 50 identifies the control device 40 that is the target of the remote operation, based on the device information, and transmits an instruction to accept the remote operation (step S52). The instruction to accept the remote operation is accompanied by an authentication code indicating that the operation terminal 50 has the right to permit remote operation of the control device 40 to the remote terminal 60, applicant information, terminal information, and setting information on the range of control.

Upon receiving the acceptance instruction from the operation terminal 50, the control device 40 authenticates the operation terminal 50 based on the authentication code (step S53), and registers the applicant information, the terminal information, and the setting information on the range of control in association with each other in the list of terminals to accept remote operation (step S54). By the processing of steps S51 to S54, the pre-registration of the remote terminal 60 that is permitted the remote operation of the control device 40 is completed.

When receiving the remote operation application from the remote terminal 60, the control device 40 authenticates the remote terminal 60 based on the applicant information, the terminal information, and the like (S56), and if the authentication result is positive, the control device 40 creates a remote operation page as shown in FIG. 5 and transmits it to the remote terminal 60 as an application result (step S57). As a result, the remote operation page is displayed on the remote terminal 60 (step S58), and when, for example, a variable is changed by an operation by the maintenance worker on the remote operation page (step S59), change information is transmitted to the control device 40. Upon receiving the change information from the remote terminal 60, the control device 40 changes the variable based on the change information (step S60).

The configuration is not limited to the present embodiment as long as the control device 40 can be controlled by the remote terminal 60. In the present embodiment, the operation terminal 50 can be connected to the control device 40 via a network line such as a LAN, but may be directly connected to the control device 40 via a wired cable, for example. Further, in the present embodiment, the remote terminal 60 can be connected to the control device 40 via the Internet 100, but the remote terminal 60 may be directly connected to the control device 40 via a wired cable, for example, since it is assumed that the maintenance contractor may be at the on-site factory.

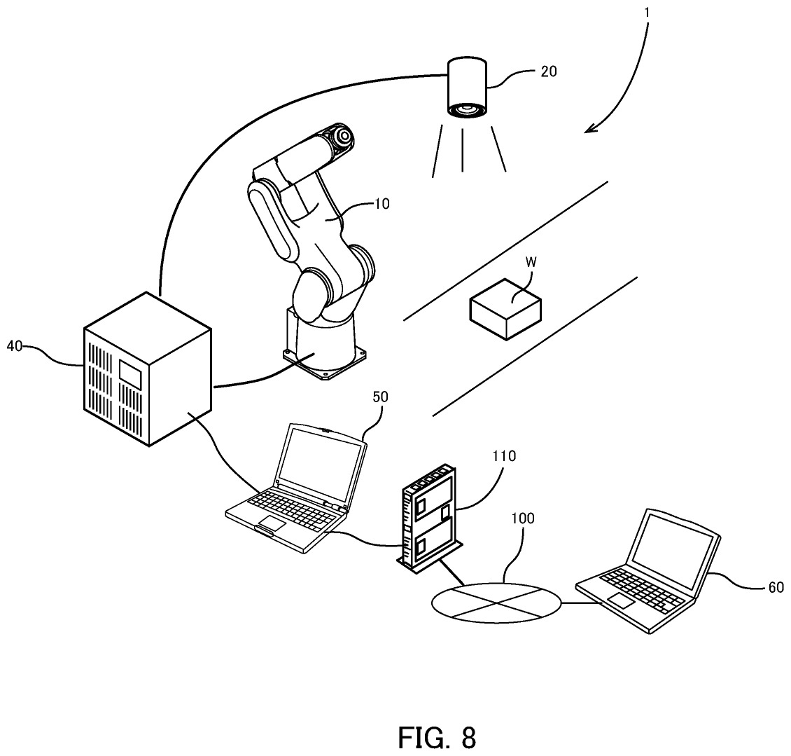

Further, the operation terminal 50 may function as a relay device for relaying between the remote terminal 60 and the control device 40. For example, as shown in FIG. 8, in the remote support system 1, the operation terminal 50 is connected to the control device 40 directly or via a network. The remote terminal 60 is connected to the operation terminal 50 directly or via a network. In this case, the operation terminal 50 permits or does not permit the remote operation of the control device 40 by the remote terminal 60. In other words, the operation terminal 50 permits or does not permit the remote operation from the remote terminal 60 to the operation terminal 50 or the control device 40. The permission or non-permission of the remote operation by the remote terminal 60 input at the operation terminal 50 is given in response to the remote operation application from the remote terminal 60. Therefore, the above-described input may be performed at the timing of performing the remote operation or may be performed in advance. Further, the operation terminal 50 sets a range of control of the control device 40 by the remote terminal 60 or a range of remote operation range of the operation terminal 50. By setting the range of control of the control device 40, the remote operator can control the control device 40 within the set control range. By setting the range of remote operation of the operation terminal 50, the remote operator can remotely operate the operation terminal 50 within the set range of remote operation, and can substantially limit the range of control of the remote operation on the control device 40.

In a state where the remote terminal 60 and the control device 40 are connected to each other, the operation terminal 50 functions as a relay device that mediates transmission and reception of data between the remote terminal 60 and the control device 40. Similar to the configuration shown in FIG. 1, the remote operator can remotely operate the control device 40 via the remote operation page displayed on the remote terminal 60. At this time, the same screen as that displayed on the remote terminal 60 may be displayed on the operation terminal 50. This allows the user to sequentially confirm how the remote operation is performed by the remote operator, whereby confirming whether or not data has been tampered with and deterring tampering by the remote operator. Of course, when the operation terminal 50 functions as a relay device for relaying between the remote terminal 60 and the control device 40, the operation terminal 50 may be remotely operated by the remote terminal 60. The remote operator can substantially operate the control device 40 by remotely operating the operation terminal 50 connected to the control device 40. In any of the above-described configurations, the operation terminal 50 can determine whether to accept the remote operation by the remote terminal 60 and set the range of control, thus ensuring on-site safety and preventing data tampering.

In the present embodiment, a control application is installed in the operation terminal 50, and the operation terminal 50 can be used by the user to operate the control device 40. However, the operation terminal 50 may be any terminal as long as the user can input permission/non-permission of remote operation to the remote terminal 60, and may be a terminal in which the control application is not be installed, that is, a terminal that cannot operate the control device 40.

In a manufacturing factory where many industrial machines are introduced, the person in charge of management may manage a plurality of industrial machines. In such a case, when a failure occurs in a plurality of industrial machines, even if the person in charge of management intends to use the remote operation service, he or she has to perform the setting or the like for remote operation for each of the industrial machines, which requires time and effort. The remote support system according to the present embodiment can be configured to include a plurality of industrial machines, a plurality of control devices 40 that control the plurality of industrial machines, respectively, and one operation terminal 50 connected to the plurality of control devices 40. The remote support system configured as described above can handle the acceptance of remote operation by the remote terminal 60 to the plurality of control devices 40 by means of one operation terminal 50. Accordingly, it is not necessary to choose whether to accept remote operation in each of the control devices 40, thereby saving time and effort related to remote support on the part of the user.

In the present embodiment, the control targets are the robot arm mechanism 10 and the camera 20. However, the control target may be industrial machines, such as a machine tool, an injection molding machine, and other computer numerical control (CNC) controlled machines. The machine tool here includes a cutting machine, an electric discharge machine, a laser machine, an ultra-precision machine, and the like. The CNC controlled machine includes a forging machine, a conveyor, a stocker, a cloth cutter, and the like. Of course, the control target may be one of these industrial machines or a system in which two or more of them are combined. Further, the control target may include sensors such as a force sensor, an acceleration sensor, and a proximity sensor.

The application page may include an input field for the range of control desired by the applicant. Informing the user of the range of control desired by the applicant allows the user to avoid a situation in which the user sets the range of control unnecessarily wide, increasing the risk of tampering, and a situation in which the user sets the range of control unnecessarily narrow, causing the range of control to be set again. In other words, it can prevent tampering by the remote operator and save time and effort related to remote operation on the part of the user.

From the viewpoint of ensuring on-site safety in remote operation, it is desirable to clarify whether or not each control item is an item related to the robot operation when setting the range of control of remote operation. In order to realize this, for example, on the reception page, the range of control related to the robot operation and the range of control not related to the robot operation are displayed separately. Alternatively, the reception page is provided so that the setting of the range of control related to the robot operation and the setting of the range of control not related to the robot operation can be performed separately. This makes it possible to avoid a situation in which the range of control related to the robot operation is erroneously set as the range of control of remote operation. It is also possible to make the user aware of the safety of the site at the time of setting the range of control of remote operation.

The items included in the range of control by remote operation are not limited to the items shown in FIG. 4 and FIG. 5. For example, the range of control may include the following items:
Addition, deletion, or update of software
Addition of an operation program
Troubleshooting
Periodic diagnosis
Confirmation of the settings of peripheral devices (camera, force sensor, etc.) and adjustment of parameters for the peripheral devices.
Confirmation and change of the settings of other applications
Direct operation of peripheral devices

With the “addition, deletion, or update of software”, the remote operator can add or delete the control software installed in the control device 40 for controlling the industrial machine, or upgrade the already installed control software to a modified version in which a new function is added or a defect is modified, on the remote operator's side such as the remote terminal 60. The control software to be added includes software for controlling vision, a force sensor, or the like newly added to the industrial machine, as well as software for a new function developed after the industrial machine is installed at the user's production site. With the “addition of an operation program”, an operation program created by off-line simulation can be added to the control device 40, or an operation program installed in another industrial machine can be copied and added to another control device 40. With the “troubleshooting”, the remote operator can analyze and resolve problems. With the “periodic diagnosis”, the remote operator can periodically confirm whether or not the industrial machines such as the robot arm mechanism 10 and the camera 20 are operating smoothly even when no trouble has occurred. With the “troubleshooting” and the “periodic diagnosis”, the remote operator may be able to confirm operation parameters and statuses that cannot be accessed with the authority of the user. It is one advantage of the configuration of the present embodiment that contents that cannot be accessed by the operation terminal 50 can be confirmed by directly controlling the control device 40 without going through the operation terminal 50.

With the “confirmation of settings of peripheral devices (camera, force sensor, etc.) and adjustment of parameters for the peripheral devices”, it is possible to directly perform from the remote terminal 60 confirmation of settings for controlling peripheral devices such as a camera and a force sensor incorporated in the industrial machine and adjustment of detailed parameters for vision detection and force control. Users are often unfamiliar with handling peripheral devices, and users can be efficiently supported through remote operation. With the “confirmation of settings of other applications”, the remote operator can confirm settings of applications used in spot welding, arc welding, laser processing, sealing, palletizing, and turn functions on and off, adjust parameters, and the like. With “direct operation of peripheral devices”, the remote operator can confirm the state of the site by operating a robot or a camera installed in the vicinity. As a result, the remote operator can freely check the part he/she wants to check, thereby enabling efficient user support through remote operation.

The items included in the range of control by remote operation may include an I/O signal for controlling communication between a hand or a peripheral device mounted on the robot arm mechanism 10 and the control device 40. As an on-site trouble, an unexpected event may cause a trouble when interlock between the control device 40 and a peripheral device or between peripheral devices does not function as expected. At this time, the remote operator can check the details of the I/O signal that controls the communication between devices, and can perform quick troubleshooting by appropriately making a correction.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A remote support system comprising:
a control device configured to control an industrial machine;
a first information processing terminal connected to the control device directly or via a network line; and
a second information processing terminal connected to the control device or the first information processing terminal directly or via the network line, wherein
the first information processing terminal permits remote operation to the control device or the first information processing terminal from the second information processing terminal.

2. The remote support system according to claim 1, wherein the first information processing terminal sets a range of the remote operation to the control device or the first information processing terminal from the second information processing terminal.

3. The remote support system according to claim 1, wherein the first information processing terminal permits the remote operation to the control device or the first information processing terminal from the second information processing terminal in response to a remote operation application from the second information processing terminal.

4. The remote support system according to claim 3, wherein the remote operation application is transferred from the control device to the first information processing terminal.

5. The remote support system according to claim 1, wherein the first information processing terminal identifies the second information processing terminal and permits the remote operation to the control device or the first information processing terminal in advance.

6. The remote support system according to claim 1, wherein the first information processing terminal is a teaching operation panel dedicated to the industrial machine.
